(19) United States
(12) Patent Application Publication
(10) Pub. No.: US 2009/0126952 A1
(43) Pub. Date: May 21, 2009

(54) Air-borne fire extinguisher system

(76) Inventor: Ted Xuan-Do, Bronx, NY (US)

Correspondence Address: Lauson & Tarver LLP, 880 Apollo Street, SUITE 301, El Segundo, CA, 90245, US

(21) Appl. No.: 11/985,596

(22) Filed: Nov. 16, 2007

(51) Int. Cl. A62C 25/00

(52) U.S. Cl. 169/53

(57) ABSTRACT

An airborne fire extinguisher system comprising a twin-rotor aircraft and a means for discharging a fire suppressant over a fire front in a target area. The means for discharging the fire suppressant comprises a retractable hose to carry the fire suppressant exiting from the container and a nozzle assembly attached to the free end of the retractable hose. A telescopic arm means achieves swinging of the retractable hose to obtain desired vertical reach and angular coverage over the fire front is coupled to the retractable hose. A nozzle assembly receiving the telescopic arm and the retractable hose at its one end amplifies the pressure of the fire suppressant before finally exiting through a hemispherical nozzle and fixed at the other end of the nozzle assembly.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to fire extinguisher systems, and more particularly to airborne fire extinguisher systems, and even more particularly to an airborne fire extinguisher system that includes a twin-rotor aircraft assembled with a means for discharging fire suppressant to extinguish fire over a target area.

Several airborne fire extinguisher systems are already known in the art. For example, U.S. Pub. No. 20060175429 to Lanigan et. al. discloses a firefighting system comprising a helicopter and a housing for storing fire suppressant material; the housing being removably connected to the helicopter. At least one cannon is connected to the housing such that the at least one cannon is automatically extendable therefrom. In order to extinguish a fire at a location, the helicopter is made to hover above that location and the at least one cannon is extended from the housing and operated so that at least some portion of the fire suppressant is released from the housing over the location so as to extinguish the fire. However, the fire extinguisher system of U.S. Pub. No. 20060175429 to Lanigan et. al. is adapted primarily for application in extinguishing fires in high-rise buildings, and the method and aircraft used for the purpose are different from the present invention.

U.S. Pat. No. 4,090,567 to Tomlinson discloses a helicopter firefighting apparatus comprising a large quick-connect and disconnect fire-fighting fluid tank, a pump mounted near the engine, a fire fighting control station on the rear of the helicopter and a nozzle broom swiveled near the control station for dispersing the fluid therethrough. The broom breaks windows for access to the fire and a hardened water-driven projectile may be propelled from the nozzle broom to break the window. However, the nozzle boom directs the fire-extinguishing fluid only over a localized portion of the fire front in the target area and differs from the nozzle assembly of the present invention.

U.S. Pat. No. 6,889,776 to Cheung discloses an apparatus which is to be used in conjunction with a container of liquid that is suspended from an aircraft flying over a ground target area. The container comprises an outlet through which the liquid enters a diffuser. The diffuser is configured to diffuse the liquid exiting the container over the target area. More particularly, the liquid is diffused horizontally outward beyond the container into the air above the target area, whereby the liquid is diffused over a wide area of the fire front in the target area so as to extinguish the fire. However, in these references, the fire suppressant container is suspended from the aircraft, differing from the detachable fire extinguisher system mounted at the bottom of the aircraft in the present invention. Further, the diffuser does not achieve substantial radial span and coverage in extinguishing the fire front as is made possible with present invention.

It is an object of the present invention to provide a fire extinguisher system that enables extinguishing fire in a target area efficiently by using a twin-rotor aircraft.

A further object is to provide a fire extinguisher system containing an easily detachable means for discharging the fire suppressant, the detachable means comprising container for fire suppressant and a nozzle assembly. The detachable means for discharging the fire suppressant is mounted to the bottom of the aircraft such that extinguishing of fire in a target area can be achieved more quickly and effectively. These and other objects of the present invention will become better understood with reference to the appended Summary, Description, and Claims.

### SUMMARY

The present invention is an airborne fire extinguisher system. The system comprises a twin rotor aircraft and a means attached to the underside of the twin-rotor aircraft for discharging fire suppressant. The twin-rotor aircraft includes a door assembly attached to the floor of the aircraft.

The means for discharging the fire suppressant comprises a container with an outlet connected to one end of a retractable hose, and other end of the retractable hose connected to a nozzle assembly through which the fire suppressant exits to attack the fire in a target area.

### BRIEF DESCRIPTION OF THE FIGURES

FIG. 1 is a side view of a fire extinguisher system in accordance with the present invention.

FIG. 2 is a top view of the system.

FIG. 3 is a side view of a nozzle assembly of the system.

FIG. 4 is a side view of a fire extinguisher system in accordance with the present invention with the nozzles deployed.

### FIGURES

### Reference Numerals

10 . . . Fire extinguisher system
12 . . . Twin-rotors
14 . . . Means for discharging fire suppressant
16 . . . Container
18 . . . Pumping Means
20 . . . Retractable hose
22 . . . Air Compressor
24 . . . Retractable Hose
26 . . . Retractable Reel
28 . . . Telescopic arm
30 . . . Ball bearing mechanism
32 . . . Nozzle assembly
34 . . . Hinged door
36 . . . Rotor assembly
38 . . . First chamber
40 . . . Second chamber
42 . . . Fan
44 . . . First rotor
46 . . . Second rotor
48 . . . Nozzle
50 . . . Ball-bearing mechanism
52 . . . Orifice

### DETAILED DESCRIPTION

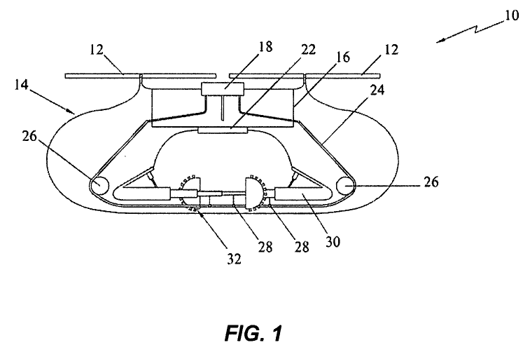

Referring to the drawings, a preferred embodiment of a airborne fire extinguisher system is illustrated and generally indicated as 10 in FIGS. 1 through 4. The system 10 is employed to attack fire fronts quickly and efficiently in a target area.

Referring to FIGS. 1 through 3, the system 10 employs an aircraft with twin rotors 12. A means 14 for discharging the fire suppressant is detachably mounted to the underside of the twin-rotor aircraft. When the aircraft is hovered above fire in the target area, the twin rotors produce high velocity wind currents (also referred as draft). The draft diffuses the fire suppressant over a wider radial distribution whereby, via the draft, the fire suppressant can spread quickly reaching a longer span and kill the fire.

The fire suppressant discharging means 14 comprises a container 16 for accommodating the fire suppressant. The container has an outlet, and is coupled to a pumping means 18 whereby the fire suppressant exits through the outlet in to a retractable hose 20. An air compressor 22 is used to power a pneumatic arm 24. The pneumatic arm 24 is coupled to the nozzle assembly 32 whereby the pneumatic arm 24 provides a controlling means to swivel, extend and attain a desired azimuth for the nozzle assembly 32. Alternatively, electro-hydraulic means can also be used as a controlling means to achieve the same results for the nozzle assembly 32. A spindle 26 based on a spring mechanism is used for winding and housing the retractable hose 20.

The retractable hose 20 is coupled to a telescopic arm 28. One end of the telescopic arm is hinged to the pneumatic arm 24. The telescopic arm 28 enables extending the reach of the retractable hose to the desired distance over fire in the target area. A ball-bearing mechanism 30 is used to accomplish an unrestricted and free motion for the retractable hose while it is in conjunction (operation) with the telescopic arm 28. The free ends of the retractable hose 20 and the telescopic arm 28 are connected to the nozzle 48.

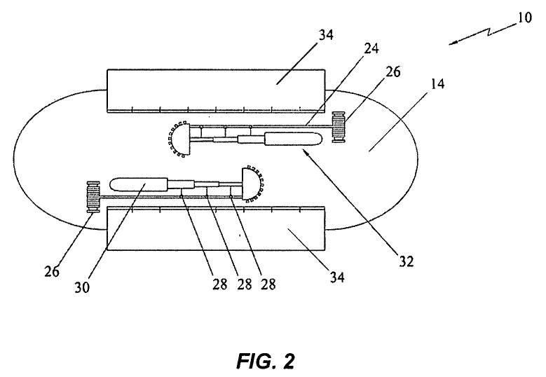

Referring to FIG. 2, a door 34 hinged to the body frame of the floor of the aircraft is used as a means to access the means for the discharging the fire suppressant.

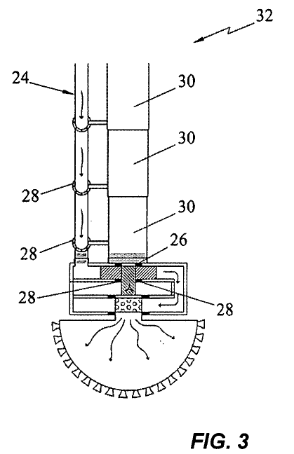

Referring to FIG. 3, the nozzle assembly 32 comprises a rotor assembly 36. The rotor assembly has two partitions with first and second chambers 38 and 40, respectively. The first chamber receives the free ends of the telescopic arm 28 and retractable hose 20. The first chamber 38 comprises a fan 42 and a first rotor 44 coupled to the fan 42. When the fire suppressant enters the first chamber 38, fan 42 is set in to rotational motion. The first rotor 44 is actuated by the fan 42 thereby further adding up increased pressure to the fire suppressant. The second chamber 40 comprises a second rotor 46 whose one end is coupled to the first rotor 44 and other end coupled to the nozzle 48. When the first rotor 44 is actuated, and simultaneously the second rotor 46 operates, thereby imparting a rotational motion to the nozzle 48. A ball-bearing mechanism 50 is employed for providing unhindered operation of the first and second rotors. The nozzle 48 is hemispherical in shape and disposed on the surface of the nozzle 48 are orifices 52 that are set spatially apart at different angles over the hemispherical surface. The fire suppressant exits through the orifices 52 killing a fire front in the target area.

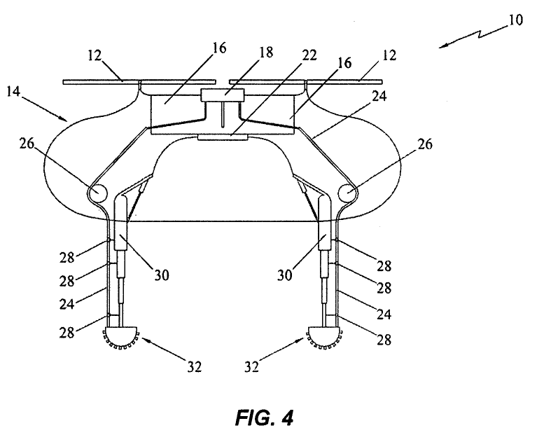

Referring to FIG. 4, in order to use the fire extinguisher system 10, the twin-rotor aircraft is hovered above a fire front in the target area. The fire suppressant in the container 16 disperses into the retractable hose 20. The retractable hose 20 is operated to achieve required vertical reach and angular sweeps over the fire in the target area. The telescopic arm 28 enables to swing the retractable hose 20 and attain desired azimuth. The fire suppressant enters the rotor assembly 36 where it is entrusted with further pressure and finally exits through the nozzle 48 killing the fire in the target area.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An air-borne fire extinguisher system comprising:
(a) a twin-rotor aircraft;
(b) at least one container for accommodating fire suppressant, the at least one container carried by the aircraft; and
(c) means for discharging the fire suppressant over fire in a target area as the twin-rotor aircraft hovers above, wherein, when the fire suppressant is being discharged, the draft produced by the aircraft causes broadening of the horizontal span of the fire suppressant discharge, thus spreading the fire suppressant over a wider target area, thereby dousing the fire more quickly, effectively and efficiently.

2. The system of claim 1, wherein the means for discharging the fire suppressant comprises:
(a) a retractable hose for transporting the fire suppressant exiting from the container; and
(b) a nozzle assembly attached to a free end of the retractable hose so that the fire suppressant discharges through the nozzle assembly.

3. The system of claim 2, wherein the means for discharging the fire suppressant further comprises a pumping means for pumping the fire suppressant into the hose.

4. The system of claim 2, wherein the means for discharging the fire suppressant further comprises:
(a) a spindle enabled by a spring mechanism whereby the spindle supports winding for the retractable hose; and
(b) a hinged telescopic arm coupled to the retractable hose.

5. The system of claim 4, wherein the discharge means further comprises a means to swing the telescopic arm (pneumatic mechanism/arm connecting to the telescopic arm, the pneumatic mechanism/arm causing the telescopic arm to swing).

6. The system of claim 5, wherein the means to swing the telescopic arm comprises a pneumatic arm.

7. The system of claim 4, wherein the means for discharging the fire suppressant comprises a ball-bearings mechanism coupled with the retractable hose, whereby the ball-bearings mechanism provides slidable and unrestricted motion while retractable hose is being extended or retracted.

8. The system of claim 4, wherein the nozzle assembly comprises:
(a) a rotor assembly with its one end connected to receive the telescopic arm and the retractable hose; and
(b) a nozzle fitted at the other end of the rotor assembly, wherein the nozzle is configured to receive and discharge the fire suppressant through a plurality of spaced-apart orifices disposed on the nozzle surface, the rotor assembly providing rotational motion to the fire suppressant discharging nozzle.

9. The system of claim 8, wherein the rotor assembly comprises:
(a) a pair of interconnected chambers, a first chamber having a fan and a first rotor, the first rotor being coupled to the fan in the first chamber such that upon receiving the fire suppressant from the retractable hose, the fan rotates and actuates the first rotor; and
(b) a second chamber having a second rotor, one end of the second rotor coupled to the first rotor so that the first rotor transmits amplified rotational power to the second rotor.

10. The system of claim 9, wherein the second rotor comprises a means to receive the fire suppressant and diffuse in to the discharge nozzle.

11. The system of claim 8, wherein the rotor assembly includes a ball-bearings mechanism so that the first and second rotors are provided unimpeded motion.

12. The system of claim 8, wherein the nozzle is shaped hemispherically and contains on its surface spaced-apart orifices through which the fire suppressant discharges.

13. The system of claim 1, wherein the twin-rotor aircraft comprises a door assembly hinged to the floor of the aircraft so as to achieve opening and closing of the means for discharging the fire suppressant.

14. The system of claim 1, wherein the fire suppressant is water, foam or gas.
